(19) United States
(12) Patent Application Publication
(10) Pub. No.: US 2026/0359651 A1
(43) Pub. Date: Nov. 12, 2026

(54) OUT-OF-DISTRIBUTION DETECTION OF MACHINE LEARNING MODEL GENERATED OUTPUTS

(71) Applicant: NEC Laboratories America, Inc., Princeton, NJ (US)

(72) Inventors: Wei Cheng, Princeton Junction, NJ (US); Wenchao Yu, Plainsboro, NJ (US); Xujiang Zhao, Hillsborough, NJ (US); Haifeng Chen, West Windsor, NJ (US)

(21) Appl. No.: 19/665,482

(22) Filed: May 1, 2026

Related U.S. Application Data
(60) Provisional application No. 63/804,103, filed on May 12, 2025.

(51) Int. Cl. G06N 3/09

(52) U.S. Cl. CPC G06N 3/09

(57) ABSTRACT

Systems and methods for out-of-distribution detection of machine learning model generated outputs. Input data can be encoded into learnable embeddings by an encoder. An out-of-distribution (OOD) loss function that determines a learnable boundary between human written data and artificial intelligence (AI) written data can be minimized based on computed boundary scores of the learnable embeddings. A classifier can be trained with a training objective including the OOD loss function to obtain a trained OOD model that detects artificial intelligence generated outputs as outputs within the learnable boundary for performing downstream tasks.

### RELATED APPLICATION INFORMATION

This application claims priority to U.S. Provisional App. No. 63/804,103, filed on May 12, 2025, incorporated herein by reference in its entirety.

### BACKGROUND

### Technical Field

The present invention relates to detecting artificial intelligence model generated outputs and more particularly to out-of-distribution detection of machine learning model generated outputs.

### Description of the Related Art

Artificial intelligence (AI) models are ubiquitous in our current workflows. For example, computer manufacturers include buttons to have easy access to AI-assisted decision making. As such, AI-generated outputs has proliferated which, consequently, blurs the reliability and accuracy of work products.

### SUMMARY

According to an aspect of the present invention, a method is provided, including, encoding input data into learnable embeddings by an encoder, minimizing an out-of-distribution (OOD) loss function that determines a learnable boundary between human written data and artificial intelligence (AI) written data based on computed boundary scores of the learnable embeddings, and training a classifier with a training objective including the OOD loss function to obtain a trained OOD model that detects artificial intelligence generated outputs as outputs within the learnable boundary for performing downstream tasks.

According to another aspect of the present invention, a system is provided, including, a memory device, one or more processor devices operatively coupled with the memory device to perform operations including, encoding input data into learnable embeddings by an encoder, minimizing an out-of-distribution (OOD) loss function that determines a learnable boundary between human written data and artificial intelligence (AI) written data based on computed boundary scores of the learnable embeddings, and training a classifier with a training objective including the OOD loss function to obtain a trained OOD model that detects artificial intelligence generated outputs as outputs within the learnable boundary for performing downstream tasks.

According to yet another aspect of the present invention, a non-transitory computer program product is provided including a computer-readable storage medium including a program code, wherein the program code when executed on a computer causes the computer to perform operations including encoding input data into learnable embeddings by an encoder, minimizing an out-of-distribution (OOD) loss function that determines a learnable boundary between human written data and artificial intelligence (AI) written data based on computed boundary scores of the learnable embeddings, and training a classifier with a training objective including the OOD loss function to obtain a trained OOD model that detects artificial intelligence generated outputs as outputs within the learnable boundary for performing downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for out-of-distribution detection of machine learning model generated outputs, in accordance with an embodiment of the present invention;

FIG. 2 is a block diagram that shows a computer system for out-of-distribution detection of machine learning model generated outputs, in accordance with an embodiment of the present invention;

FIG. 3 is a block diagram that shows components of a computer system for out-of-distribution detection of machine learning model generated outputs, in accordance with an embodiment of the present invention;

FIG. 4 is a block diagram that shows representations for out-of-distribution detection of machine learning model generated outputs, in accordance with an embodiment of the present invention; and

FIG. 5 is a flow diagram that shows a high-level overview of distribution detection of machine learning model generated outputs, in accordance with an embodiment of the present invention.

### DETAILED DESCRIPTION OF PREFERRED EMBODIMENTS

In accordance with embodiments of the present invention, systems and methods are provided for out-of-distribution detection of machine learning model generated outputs.

In the present embodiments, input data can be encoded into learnable embeddings by an encoder. An out-of-distribution (OOD) loss function that determines a learnable boundary between human written data and artificial intelligence (AI) written data can be minimized based on computed boundary scores of the learnable embeddings. A classifier can be trained with a training objective including the OOD loss function to obtain a trained OOD model that detects artificial intelligence generated outputs as outputs within the learnable boundary for performing downstream tasks.

In recent years, with the continuous iteration and rapid advancement of large language models (LLMs), the adoption of AI-powered products in everyday life and professional settings has increased significantly. While these models have greatly enhanced productivity and efficiency, they also pose risks of misuse. The phenomenon of hallucinations-instances where LLMs generate incorrect or misleading content—can lead to serious consequences if such outputs are inadvertently relied upon. As LLMs become increasingly powerful, the development of corresponding methods to detect AI-generated content has become an urgent research priority. There is a critical need for detection techniques that are stable, robust, and accurate in distinguishing machine-generated text from human-written content.

Despite increasing interest in detecting machine-generated text, current detection approaches exhibit notable limitations. Broadly, existing methods can be categorized into three groups: watermarking techniques, zero-shot statistical methods, and training-based approaches.

Watermarking methods embed identifiable signals into generated content during inference, offering strong detection when the model is cooperative, but failing entirely in black-box or adversarial settings.

Zero-shot statistical methods, which rely on distributional differences (e.g., perplexity or probability density), are model-agnostic and do not require training, making them flexible and efficient. But their performance is often unstable across domains and text lengths.

In contrast, training-based methods-typically implemented as supervised classifiers trained on labeled examples, often achieve higher detection accuracy. Nevertheless, these methods require labeled data and may generalize poorly across domains or unseen models.

Despite their differences, most existing detectors, whether zero-shot or supervised, treat the detection as a binary classification task, aiming to distinguish between the distributions of human-written and LLMs-generated content by identifying an optimal decision boundary or threshold between their respective distributions. However, this binary classification paradigm carries inherent limitations. There is a prevalent issue on how human-written text is treated. Human language is inherently diverse: each author, writing style, domain, or genre may follow distinct linguistic patterns, leading to a wide range of underlying distributions. Yet, in typical binary classification settings, the human-written samples used for training are sparse and limited in scope, failing to capture the full variability of human expression.

This introduces a problematic asymmetry. Treating both machine and human text as learnable, well-defined distributions implicitly assumes comparable internal consistency on both sides—an assumption that is rarely valid for human language. Instead, human written text should be viewed as originating from an unknown, heterogeneous distribution, one that is inherently difficult to model with finite samples. In contrast, machine-generated text—often produced by a specific model or family of models—tends to share common features and can be more reliably approximated as a unified distribution.

This shift in perspective highlights a key limitation of existing detection frameworks: by imposing a rigid decision boundary between two imbalanced and fundamentally different distributions, the detection frameworks risk overfitting to the narrow subset of human data seen during training, while underestimating the broader diversity of real-world human language.

The in-distribution (ID) region, representing machine-generated text, is compact and well-covered by training data. However, human-written text corresponds to a vast and multimodal out-of-distribution (OOD) space. A binary classifier, trained on limited human samples (a small subset of the OOD space), tends to overfit to these samples and draws a brittle decision boundary that fails to generalize. In contrast, OOD detection methods focus on modeling only the in-distribution region and treat anything outside it as unknown, offering a more robust and theoretically sound alternative.

Traditionally, this problem has been framed as a binary classification task, where the detector is trained to distinguish between human-written and machine-generated samples using supervised learning. Formally, given a dataset of human-written texts x~Pₕᵤₘₐₙ and machine-generated texts x~P_{machine}, the goal is to train a classifier f: X→{0, 1} that distinguishes between the two distributions. However, this formulation assumes that both Pₕᵤₘₐₙ and P_{machine} can be adequately approximated using finite training samples. f(x)∈{0, 1}, where

$$\{ \begin{matrix}f ( x ) = 0 , if x \sim {P}_{human} \\ f ( x ) = 1 , if x \sim {P}_{machine}\end{matrix}$$

However, human-written text can correspond to an open-world, highly heterogeneous distribution, composed of diverse styles, domains, and author-specific traits. As such, Pₕᵤₘₐₙ cannot be meaningfully represented using a limited training subset. This asymmetry introduces a fundamental problem: the binary classifier overfits to the limited observed subset of human data P′ₕᵤₘₐₙ ∈Pₕᵤₘₐₙ, leading to poor generalization and spurious decision boundaries.

Therefore, machine-generated text detection can be reformulated as an OOD detection task, where the machine-generated distribution P_{machine}=Pᵢₙ is modeled explicitly, and any deviation from it is treated as out-of-distribution Pₕᵤₘₐₙ=Pout={x|x/~Pᵢₙ}. This set may include texts from unseen domains, stylistic outliers, noisy generations, languages, authors, or other edge cases not represented in the training data.

To validate this, a range of established OOD detection methods can be evaluated for the task of identifying machine-generated text. These include both classical and neural one-class approaches, applied directly to the latent embeddings of AI-generated content. Their performance were benchmarked against traditional training-based binary classifiers under the same experimental conditions. Remarkably, multiple OOD-based methods not only achieve superior or comparable detection performance, but also do so without requiring extensive hyperparameter tuning or model-specific adaptation. This robustness holds across diverse datasets, model types, and generation settings, providing strong empirical support for our core assumption—that machine generated texts form a distributional core, while human-authored texts behave as outliers in feature space.

The present embodiments increase the accuracy of determining AI-generated outputs based on their performance in classification baselines (e.g., area under receiver operating characteristic curve, area under precision-recall curve, false positive rate, etc.) while reducing the system complexity and computational resource usage with reduced training epochs compared to other zero-shot and training-based method (e.g., in some instances having an increase of at least 40 percent for zero-shot and training-based methods). Additionally, issues regarding hallucinations can be resolved by the present embodiments by detecting AI-generated outputs.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

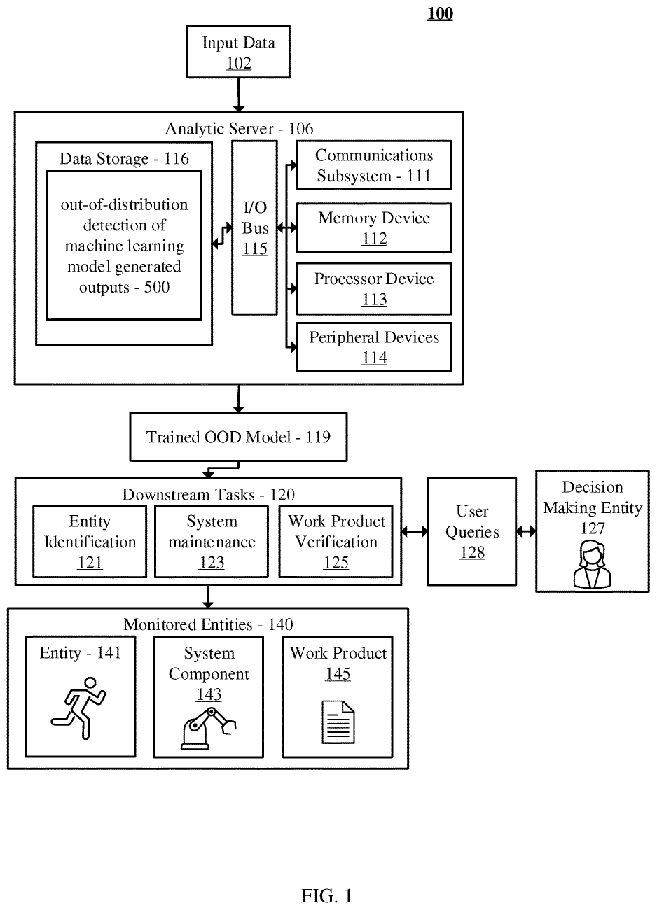

Referring now in detail to the figures in which like numerals represent the same or similar elements and initially to FIG. 1, a block diagram shows a system for out-of-distribution detection of machine learning model generated outputs, in accordance with an embodiment of the present invention.

In an embodiment using a system 100, monitored entities 140 can include entity 141, system component 143, and work product 145. The monitored entities 140 can generate an input data 102 that include image/video or texts. The input data 102 can be transmitted to an analytic server 106 that can implement out-of-distribution detection of machine learning model generated outputs 500. The analytic server 106 can train a machine learning model and obtain a trained out-of-distribution (OOD) model 119. The trained OOD model 119 can be utilized to perform downstream tasks 120.

System 100 can be utilized to perform downstream tasks 120 based on the input data 102 and user queries 128 from a decision-making entity 127. The downstream tasks 120 can include entity identification 121, system maintenance 123, and work product verification 125. The analytic server 106 can generate a corrective action for the downstream tasks 120 to be sent to respective computing systems for the monitored entities 140 through a network.

In entity identification 121, the input data 102 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The trained OOD model 119 can predict future attributes, and relationships of the entity 141, and whether an AI model was utilized to alter entity attributes from the input data 102.

Based on the predictions of the trained OOD model 119, a corrective action can be generated. The corrective action can include notifying the decision making entity 127 of the predictions about the entity 141 based on their input data 102 related to the potential AI model alterations, generating resolutions to an issue caused by the entity (e.g., the entity 141 as an altered image of a disabled vehicle in a traffic scene and the resolution is the deployment of a repair technician, etc.) of the input data 102 to help with the decision making process of the decision making entity 127, etc.

In system maintenance 123, input data 102 (e.g., system logs, test cases, hardware status images, etc.) related to the system component 143 can be processed to answer user queries 128. The user queries 128 can be relevant on how to properly maintain the system component 143 based on the input data 102. The trained OOD model 119 can detect AI generated updates (e.g., configuration, programming code, log entries, etc.) to the system component 143. A corrective action can be generated by the analytic server 106 which can include the answers to the user queries 128 (e.g., determine causes to bandwidth issues, etc.) to maintain the system component 143 after a determination of AI generated updates (e.g., incorrect configuration, update code, log entry, etc.) that caused operational issues to the system. Based on the corrective action (e.g., adding bandwidth, blocking packets from an identified internet protocol (IP) address to resolve malicious attacks, restarting hardware, reverting updates, etc.) the network system can be autonomously maintained.

In work product verification 125, input data 102 (e.g., documents, user interface, user experience, etc.) related to the work product 145 can be processed to answer user queries 128. The trained OOD model 119 can detect whether AI generated output was utilized to generate the work product 145. The user queries 128 can be relevant to how the work product 145 was generated. A corrective action can be generated by the analytic server 106 which can include the answers to the user queries 128 to control the proper generation of the work product 145. Based on the corrective action (e.g., regeneration of documents, user interface, user experience, removal of inappropriate content determined as AI-generated, etc.) the work product 145 can be autonomously generated.

Other downstream tasks and practical applications are contemplated.

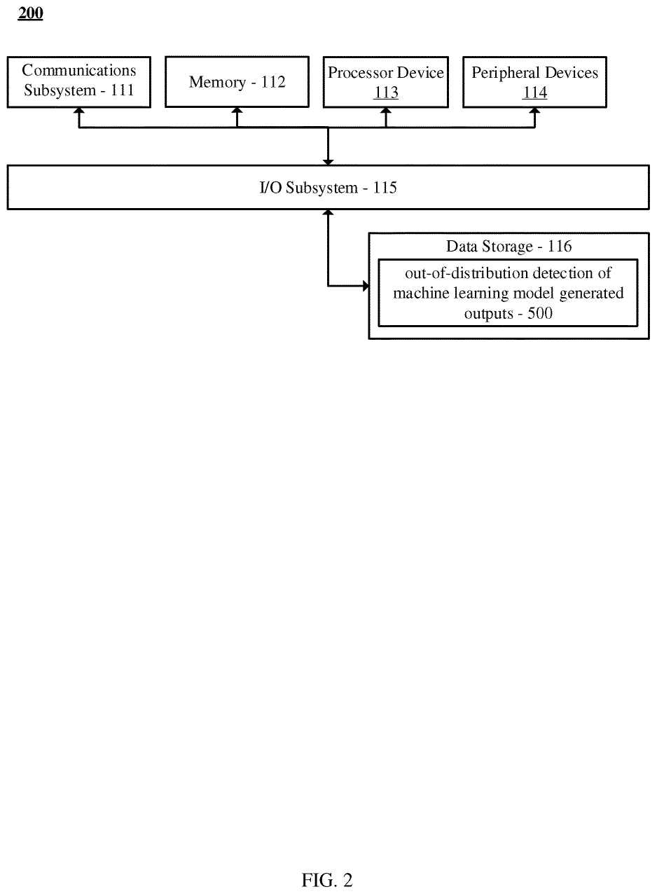

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for out-of-distribution detection of machine learning model generated outputs, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, extracted control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single extracted circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for out-of-distribution detection of machine learning model generated outputs 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

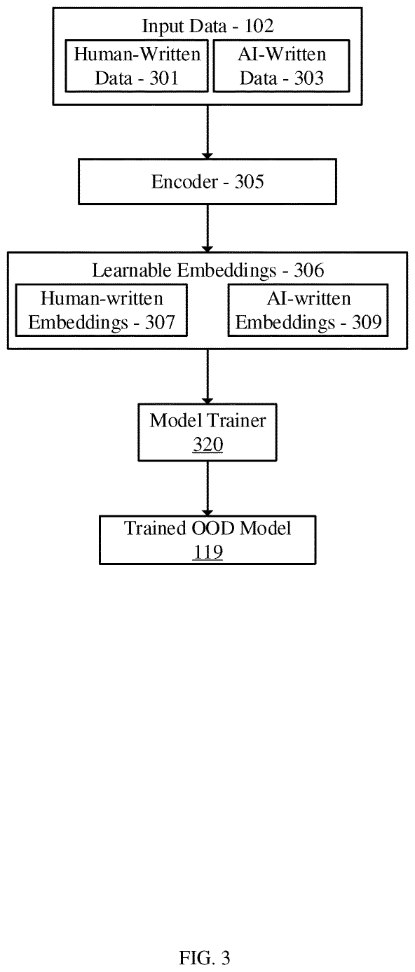

Referring now to FIG. 3, a block diagram shows components of a computer system for out-of-distribution detection of machine learning model generated outputs, in accordance with an embodiment of the present invention.

In an embodiment, input data 102 can be processed by a text encoder 305 to generate learnable embeddings 306 for a model trainer 320 to obtain a trained OOD model 119. The trained OOD model 119 can detect AI generated outputs based on the input data 102.

The learnable embeddings 306 can include human-written embeddings 307 and AI-written embeddings 309 determined by the text encoder 305 from human written data 301 and AI-written data 303, respectively. The learnable embeddings 306 include vectors representing tokens from input data (e.g., human written data 301 and AI-written data 303) that can be treated as trainable model parameters of the trained OOD model 119. The trained OOD model 119 can utilize artificial neural networks.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

In an embodiment, the trained OOD model 119 can be trained by minimizing an out-of-distribution loss function that compares an output value generated by the trained ML model 119 based on a validation dataset and training data and determine whether an input data is AI-written or human written.

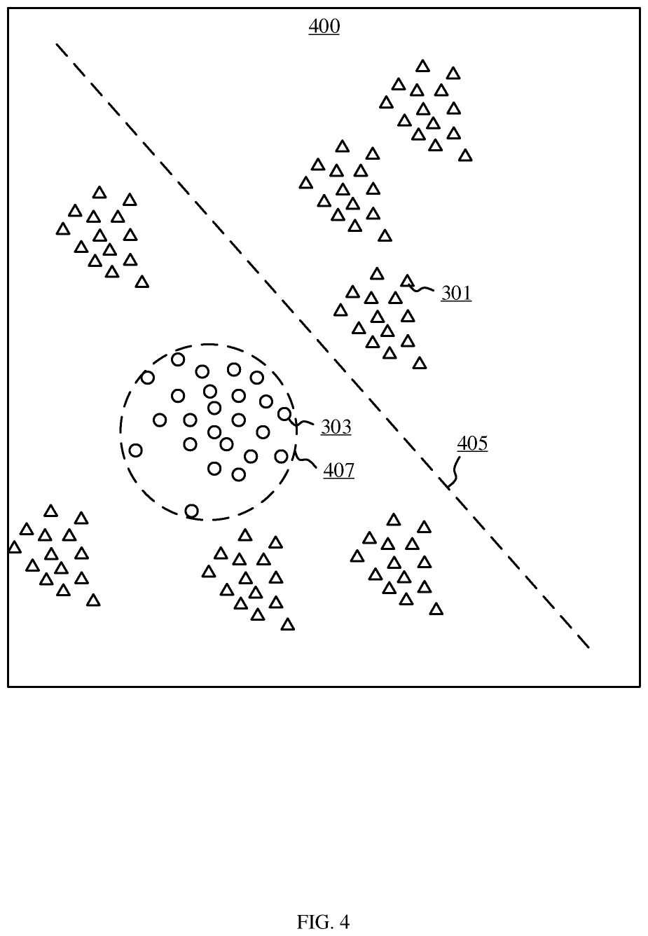

Referring now to FIG. 4, a block diagram shows representations for out-of-distribution detection of machine learning model generated outputs, in accordance with an embodiment of the present invention.

In an embodiment, process 400 utilizes human written data 301 and AI-written data 303 to classify AI-written data for generating training data to detect AI generated outputs. Binary classification 405 separates the input data 102 (e.g., human written data 301 and AI-written data 303) but fails to correctly classify them. Learnable boundary 407 clusters the AI-written data 303 as in-distribution to separate them from the human written data 301. As such, in-distribution data can be learned as AI-generated, while out-of-distribution data can be learned as human-generated.

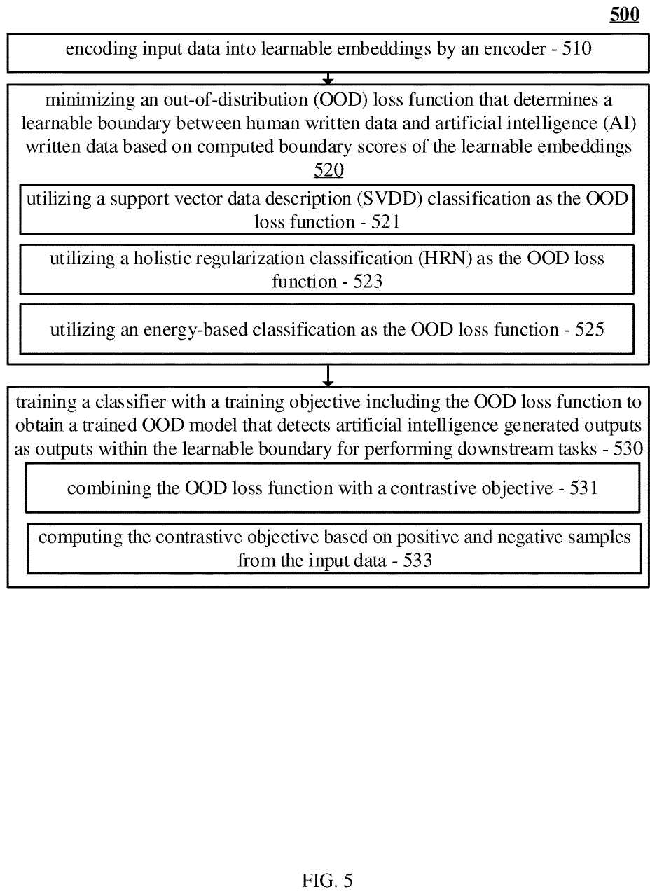

Referring now to FIG. 5, a flow diagram shows a high-level overview of distribution detection of machine learning model generated outputs, in accordance with an embodiment of the present invention.

In an embodiment, input data can be encoded into learnable embeddings by an encoder. An out-of-distribution (OOD) loss function that determines a learnable boundary between human written data and artificial intelligence (AI) written data can be minimized based on computed boundary scores of the learnable embeddings. A classifier can be trained with a training objective including the OOD loss function to obtain a trained OOD model that detects artificial intelligence generated outputs as outputs within the learnable boundary for performing downstream tasks.

In block 510, input data can be encoded by an encoder into learnable embeddings. In an embodiment, the input data 102 can be encoded by encoder 305 to obtain learnable embeddings 306. The learnable embeddings 306 can include human-written embeddings 307 corresponding to human-written data 301 and AI-written embeddings 309 corresponding to AI-written data 303.

In block 520, an out-of-distribution (OOD) loss function that determines a learnable boundary between human written data and artificial intelligence (AI) written data can be minimized based on a computed boundary score of the learnable embeddings. The OOD loss functions can include one-class learning methods that model only the in-distribution (LLM-generated text) and identify human-written text as outliers. Each offers perspectives on how to characterize the in-distribution and define deviation.

In block 521, a support vector data description (SVDD) classification can be utilized as the OOD loss function. SVDD is a one-class classification method that learns a compact hypersphere in the latent space to enclose the representations of in-distribution samples. Formally, it minimizes the following objective:

$${ℒ}_{DSVDD} = \frac{1}{N} {\sum }_{i = 1}^{N} {‖ {ϕ}_{θ} ( {x}_{i} ) - c ‖}^{2} .$$

The objective is utilized to compute and minimize the boundary score which can include the distance of machine-generated samples from the center c, which is intuitively the radius of the hypersphere, thereby ensuring that learnable embeddings 306 of machine generated texts lie close to the center.

Unlike binary classification, which attempts to model both classes under low-entropy supervision, SVDD learns the compact support of machine text, while allowing high-entropy human texts to remain unconstrained, treating any outlier as likely authored by a human.

During inference, the boundary score is compared to a threshold, and if the boundary score exceeds a threshold, the text is flagged as out-of-distribution and thus considered human-written. The threshold can be computed based on a validation dataset. For example, if for the validation datasets, the average distances of a score for AI-written data is 0.1, and the average distances of a score for human-written is 1, then the threshold can be 0.2.

In block 523, a holistic regularization classification (HRN) can be utilized as the OOD loss function. HRN is a one-class learning method that enforces holistic feature utilization and regularizing model confidence. It directly outputs a boundary score that includes scalar score and uses the following training loss:

$${ℒ}_{HRN} = {𝔼}_{x \sim {𝒟}_{in}^{train}} [ - log ( Sigmoid ( f ( ϕ ( x ) ) ) ] + λ \cdot {‖ {∇}_{x} f ( ϕ ( x ) ) ‖}_{2}^{n} ] ,$$

classifier, φ(x) is the high-dimensional embedding, Sigmoid (·) ∈(0, 1) is a score mapping the one class head to logit, and n and λ are hyper-parameters controlling the strength of the penalty and balancing the regularization respectively. HRN only has one class/head in the output, it uses Sigmoid (f(φ(x))) as a score or the probability of given text x belonging to the in-class.

The first term encourages the model to assign high confidence to in-distribution inputs, while the second H-regularization term penalizes excessive sensitivity to specific input directions, promoting more robust and generalizable decision functions.

During inference time, texts with low sigmoid scores are considered as OOD samples, which is human-written text.

In block 525, an energy-based classification can be utilized as the OOD loss function. Energy-based classification methods assign a boundary score which includes an energy score E(x) to each input, indicating its compatibility with the in-distribution. Lower energy implies higher likelihood of being in-distribution. The energy score of a sample is defined from softmax logits f(x) as: E(x)=−log Σᵢ exp (fᵢ(x)), where fᵢ(⋅) indicates the model logits for class i. To improve separation between ID and OOD samples, an energy-bounded learning objective that explicitly encourages an energy gap can be utilized during training. This involves fine-tuning the model with an augmented loss that combines the standard cross-entropy loss with an energy regularization term:

$${{ℒ}_{energy} = {𝔼}_{( x , y ) \sim {𝒟}_{in}^{train}} [ - log {F}_{y} ( x ) ] + λ \cdot = \{ {𝔼}_{( x , y ) \sim {𝒟}_{in}^{train}} [ max ( 0 , E ( x ) ) - {m}_{in} )}^{2} ] + {𝔼}_{( x , y ) \sim {𝒟}_{out}^{train}} [ {max ( 0 , {m}_{out} - E ( x ) )}^{2} ] \} ,$$

where F_{y}(x) is the softmax output of the classifier. This loss penalizes in-distribution samples whose energy exceeds a predefined margin mᵢₙ, and simultaneously penalizes OOD samples with energy lower than another threshold mouth. The resulting model learns a contrastively shaped energy surface, creating a clearer margin between ID and OOD samples in energy space. This enhances the reliability and robustness of energy scores as OOD indicators during inference.

During inference, the energy score E(x) is computed for a given input using the log-sum-exp of the softmax logits. An input is classified as out-of-distribution if its negative energy score −E(x) falls below a predefined threshold.

In block 530, a classifier can be trained with a training objective including the OOD loss function to obtain a trained OOD model that detects artificial intelligence generated outputs as outputs within the learnable boundary for performing downstream tasks.

In block 531, the training objective can be computed by combining the OOD loss function with a supervised contrastive objective: [symbol] ₜₒₜₐₗ=α· [symbol] _{OOD}+β· [symbol] _{contrastive}, [symbol] _{OOD} ∈{ [symbol] _{DSVDD}, [symbol] _{HRN}, [symbol] _{energy}}, where α and β are weighting coefficients. The model trainer 320 can minimize the training objective. This joint training scheme allows the encoder to benefit from both unsupervised in-distribution modeling and supervised human-machine discrimination, leading to more robust representation learning.

In block 533, the contrastive objective can be computed based on positive and negative samples from the input data. In an embodiment, the contrastive objective is utilized to further enhance the model's ability to distinguish between human and machine-generated text, during training, the contrastive loss can be computed as:

$${ℒ}_{contrastive} = - log \frac{exp ( {\sum }_{z ∈ {Z}^{+}} \frac{S ( q , z )}{τ} / {N}_{{Z}^{+}} )}{exp ( {\sum }_{z ∈ {Z}^{+}} \frac{S ( q , z )}{τ} / {N}_{{Z}^{+}} ) + exp ( {\sum }_{z ∈ {Z}^{-}} \frac{S ( q , z )}{τ} )}$$

where q is the current sample, Z⁺ is the collection of positive samples, while Z⁻ is the collection of negative samples, N_{Z}_{⁺} is the size of positive sample collection, τ refers to the temperature coefficient, S(⋅) is the similarity computation, which can be cosine similarity. In another embodiment, other similarity comparisons can be utilized such as Euclidean distance.

After training, the trained OOD model 119 can be utilized for performing downstream tasks 120.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
encoding input data into learnable embeddings by an encoder;
minimizing an out-of-distribution (OOD) loss function that determines a learnable boundary between human written data and artificial intelligence (AI) written data based on computed boundary scores of the learnable embeddings; and
training a classifier with a training objective including the OOD loss function to obtain a trained OOD model that detects artificial intelligence generated outputs as outputs within the learnable boundary for performing downstream tasks.

2. The method of claim 1, wherein minimizing the OOD loss function further comprises utilizing a support vector data description (SVDD) classification as the OOD loss function.

3. The method of claim 1, wherein minimizing the OOD loss function further comprises utilizing a holistic regularization classification (HRN) as the OOD loss function.

4. The method of claim 1, wherein minimizing the OOD loss function further comprises utilizing an energy-based classification as the OOD loss function.

5. The method of claim 1, wherein training the classifier further comprises combining the OOD loss function with a contrastive objective.

6. The method of claim 5, wherein training the classifier further comprises computing the contrastive objective based on positive and negative samples from the input data.

7. The method of claim 1, further comprising removing inappropriate content determined as AI-generated output from a work product to support decision-making of a decision-making entity.

8. A system, comprising:
a memory device;
one or more processor devices operatively coupled with the memory device to perform operations including:
encoding input data into learnable embeddings by an encoder;
minimizing an out-of-distribution (OOD) loss function that determines a learnable boundary between human written data and artificial intelligence (AI) written data based on computed boundary scores of the learnable embeddings; and
training a classifier with a training objective including the OOD loss function to obtain a trained OOD model that detects artificial intelligence generated outputs as outputs within the learnable boundary for performing downstream tasks.

9. The system of claim 8, wherein minimizing the OOD loss function further comprises utilizing a support vector data description (SVDD) classification as the OOD loss function.

10. The system of claim 8, wherein minimizing the OOD loss function further comprises utilizing a holistic regularization classification (HRN) as the OOD loss function.

11. The system of claim 8, wherein minimizing the OOD loss function further comprises utilizing an energy-based classification as the OOD loss function.

12. The system of claim 8, wherein training the classifier further comprises combining the OOD loss function with a contrastive objective.

13. The system of claim 12, wherein training the classifier further comprises computing the contrastive objective based on positive and negative samples from the input data.

14. The system of claim 8, further comprising removing inappropriate content determined as AI-generated output from a work product to support decision-making of a decision-making entity.

15. A non-transitory computer program product comprising a computer-readable storage medium including a program code, wherein the program code when executed on a computer causes the computer to perform operations including:
encoding input data into learnable embeddings by an encoder;
minimizing an out-of-distribution (OOD) loss function that determines a learnable boundary between human written data and artificial intelligence (AI) written data based on computed boundary scores of the learnable embeddings; and
training a classifier with a training objective including the OOD loss function to obtain a trained OOD model that detects artificial intelligence generated outputs as outputs within the learnable boundary for performing downstream tasks.

16. The non-transitory computer program product of claim 15, wherein minimizing the OOD loss function further comprises utilizing a support vector data description (SVDD) classification as the OOD loss function.

17. The non-transitory computer program product of claim 15, wherein minimizing the OOD loss function further comprises utilizing a holistic regularization classification (HRN) as the OOD loss function.

18. The non-transitory computer program product of claim 15, wherein minimizing the OOD loss function further comprises utilizing an energy-based classification as the OOD loss function.

19. The non-transitory computer program product of claim 15, wherein training the classifier further comprises combining the OOD loss function with a contrastive objective.

20. The non-transitory computer program product of claim 19, wherein training the classifier further comprises computing the contrastive objective based on positive and negative samples from the input data.
